(19) United States
(12) Patent Application Publication
(10) Pub. No.: US 2025/0054269 A1
(43) Pub. Date: Feb. 13, 2025

(54) SYSTEM AND METHOD FOR GENERATING FEATURE DATA

(71) Applicant: HERE Global B.V., Eindhoven (NL)

(72) Inventors: Hai YU, San Diego, CA (US); Xiaoying JIN, Boulder, CO (US); Amey AROSKAR, North Aurora, IL (US)

(21) Appl. No.: 18/232,107

(22) Filed: Aug. 9, 2023

(51) Int. Cl. G06V 10/44; G06T 3/40; G06T 5/20; G06T 7/12; G06V 10/771; G06V 20/13; G06V 20/17

(52) U.S. Cl. CPC G06V 10/44; G06T 3/40; G06T 5/20; G06T 7/12; G06V 10/771; G06V 20/13; G06V 20/17; G06T 2207/20132; G06T 2207/30256

(57) ABSTRACT

An approach is provided for generating feature data. The approach, for example, involves determining a set of break points associated with at least one road feature based on mask image data. The mask image data is associated with overhead image data comprising the at least one road feature. The approach further involves generating a set of cropped feature maps based on processing of a global feature map obtained from a global feature segmentation model and the set of break points. The global feature map is associated with the overhead image data. The approach further involves generating the feature data associated with the at least one road feature based on application of a local feature detection model on the generated set of cropped feature maps and the set of break points. The approach further involves storing the generated feature data in a geographic database.

### BACKGROUND

Generally, roads such as urban roads may be connected with each other, with a large length to width ratio, forming a road network with high connectivity. Typically, data associated with the roads that includes features of the road network or the roads may be essential in the generation of digital maps. In an example, a road feature such as a road boundary may be extracted to obtain road surface edge skeletons, that may be topologically continuous linear linkages or loops. The data associated with the roads may be obtained by using various sources, for example, by use of satellite images, aerial images, and the like. Such data may be utilized to extract the road features of the roads.

Notably, the extraction of enhanced quality road features, such as the road boundary from the data associated with the roads, such as the satellite images and the aerial images may have several challenges. For example, rich details of ground features may add complexity, such as composite lane structures, and complex color scheme. Further, existence of several geometric topological features next to road segments may make it difficult to extract the road boundary feature. Furthermore, the extraction may be difficult due to occlusion from the road and next-to-road objects, such as vehicles, vegetation, constructions and so forth. Moreover, there may be shadow cast from adjacent three-dimensional (3D) structures, like trees and the buildings on the road boundary. There may further be inconsistencies with orthorectification processes applied to the satellite and aerial images. In many cases, the road boundaries may not have distinguishable feature representation from other road surfaces or may have a similar texture to objects, such as parking lots, sidewalks, and the like.

Conventional methods try to solve the abovementioned challenges, however none of the methods have been able to successfully extract the enhanced quality road features. For example, some existing methods achieve high semantic accuracy however they fail to honor a topology of the road boundary along a complete body of the road networks. Other methods achieve a reasonable regional road boundary completion but fail to reach an optimum road boundary discovery rate from complicated environmental backgrounds in the data. Some typical methods for detecting the road features may include hand-crafted feature extraction and a subsequent curve-fitting process for the road features. Such methods may work well only in limited circumstances and may hardly cope with complicated road crossing, merging, and splitting situations of the road networks, and are notoriously expensive considering the amount of working time required to extract the features of e.g., an entire country's road network.

Moreover, conventional deep learning based semantic segmentation models may be utilized to achieve high recall and precision rates in detection of the road features after being trained with human annotated examples. However, problems the semantic segmentation models may face is that they have inferior topology correctness, especially when road intersections or road merges/splits are encountered. The semantic segmentation models may have short of instance awareness, road topological connectivity and road edge instance completeness. Thus, in such conventional methods, the detected road features may be fragmented and incomplete. Furthermore, in the case of occlusion or background similarity, vague predictions for the road features may be present, thereby providing unreliable and inaccurate results.

Therefore, there is a need for improved systems and methods for accurate and reliable detection of the road features in the road networks to generate feature data.

### SOME EXAMPLE EMBODIMENTS

According to one embodiment, a system for generation of feature data is provided. The system comprises at least one processor, and at least one memory including computer program code for one or more computer programs, the at least one memory and the computer program code configured to, with the at least one processor, cause, at least in part, the system to determine a set of break points associated with at least one road feature based on mask image data. The mask image data is associated with overhead image data comprising the at least one road feature. The system is also caused to generate a set of cropped feature maps based on processing of a global feature map obtained from a global feature segmentation model and the set of break points. The global feature map is associated with the overhead image data. The system is also caused to generate the feature data associated with the at least one road feature based on application of a local feature detection model on the generated set of cropped feature maps and the set of break points. Further, the system is caused to store the generated feature data in a geographic database.

According to another embodiment, a method for generating feature data is provided. The method comprises determining a set of break points associated with at least one road feature based on mask image data. The mask image data is associated with overhead image data comprising the at least one road feature. The method further comprises generating a set of cropped feature maps based on processing of a global feature map obtained from a global feature segmentation model and the set of break points. The global feature map is associated with the overhead image data. The method further comprises generating the feature data associated with the at least one road feature based on application of a local feature detection model on the generated set of cropped feature maps and the set of break points. The method further comprises storing the generated feature data in a geographic database.

According to another embodiment, a non-transitory computer-readable storage medium carries one or more sequences of one or more instructions which, when executed by one or more processors, cause, at least in part, an apparatus to perform operations. The operations comprise determining a set of break points associated with at least one road feature based on mask image data. The mask image data is associated with overhead image data comprising the at least one road feature. The operations further comprise generating a set of cropped feature maps based on processing of a global feature map obtained from a global feature segmentation model and the set of break points. The global feature map is associated with the overhead image data. The operations further comprise generating the feature data associated with the at least one road feature based on application of a local feature detection model on the generated set of cropped feature maps and the set of break points. The operations further comprise storing the generated feature data in a geographic database.

In addition, for various example embodiments described herein, the following is applicable: a computer program product may be provided. For example, a computer program product comprising instructions which, when executed by a computer, cause the computer to perform any one or any combination of methods, operations, or processes disclosed herein.

According to another embodiment, an apparatus comprises means for determining a set of break points associated with at least one road feature based on mask image data. The mask image data is associated with overhead image data comprising the at least one road feature. The apparatus further comprises generating a set of cropped feature maps based on processing of a global feature map obtained from a global feature segmentation model and the set of break points. The global feature map is associated with the overhead image data. The apparatus further comprises generating the feature data associated with the at least one road feature based on application of a local feature detection model on the generated set of cropped feature maps and the set of break points. The apparatus further comprises storing the generated feature data in a geographic database.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for conducting the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating feature data, according to one embodiment;

FIG. 2 is a diagram of components of a mapping platform capable of generating the feature data, according to one embodiment;

FIG. 3 is a diagram depicting generation of mask image data by use of a global feature segmentation model, according to one embodiment;

FIG. 4 is a diagram depicting determination of a set of break points, according to one embodiment;

FIG. 5 is a diagram depicting determination of a plurality of vertices, according to one embodiment;

FIG. 6 is a diagram depicting usage of a cropped feature map for the determination of the plurality of vertices, according to one embodiment;

FIG. 7 is a diagram depicting the determined plurality of vertices associated with an overhead image data, according to one embodiment;

FIG. 8 is a diagram of a method depicting usage of the mask image data and the plurality of vertices to generate the feature data, according to one embodiment;

FIG. 9 is a flowchart of a method for generating the feature data, according to one embodiment;

FIG. 10 is a diagram of a geographic database, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset, vehicle, or part thereof) that can be used to implement an embodiment.

### DESCRIPTION OF SOME EMBODIMENTS

Examples of a system, method, and computer program for generating feature data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

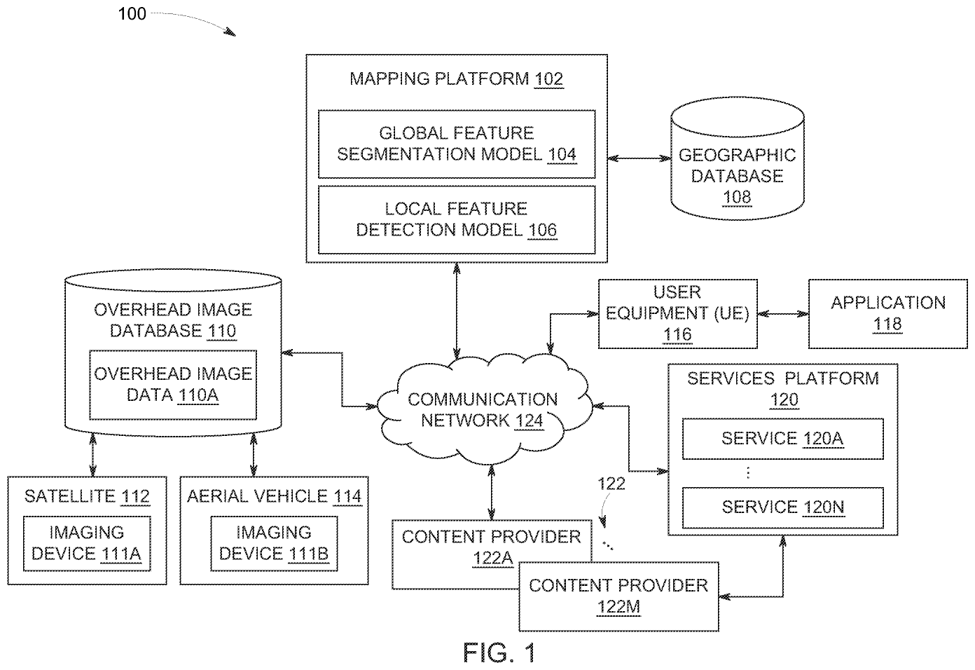

FIG. 1 is a diagram of a system 100 capable of generating the feature data, according to one embodiment. The system 100 may include a mapping platform 102. The mapping platform 102 may include a global feature segmentation model 104 and a local feature detection model 106. The mapping platform 102 may be associated with a geographic database 108. The system 100 may further include an overhead image database 110 that includes overhead image data 110A. The system 100 may further include a satellite 112 associated with an imaging device 111A or an aerial vehicle 114 associated with an imaging device 111B. The imaging devices, such as the imaging device 111A and the imaging device 111B may output the overhead image data 110A. The system 100 may further include a user equipment (UE) 116, an application 118, a services platform 120, a content provider 122 and a communication interface 124. The services platform 120 may include, for example, a service 120A and a service 120B. The content provider 122 may include, for example, a content provider 122A and a content provider 122B. The content provider 122 or the services platform 120 may provide similar data and/or functionality to an overhead image database, such as the overhead image database 110.

Generally, the feature data may include, for example, data of road features, such as road boundary, lane(s), road centerline, lane centerline, or road markings associated therewith. Moreover, the road features may be considered to be linear road features. Typically, imagery, such as satellite images and aerial images may be utilized to view an overhead view of the roads and to generate the feature data corresponding to the road features. However, conventional systems that may be used to generate the feature data face several challenges. For example, processing rich details, such as color and complex texture of ground features may be difficult, require increased processing resources and extend processing time. Further, processing may further be challenging due to surrounding objects having a similar texture and color to the road features. In addition, several geometric topological features next to road segments may make it difficult to extract the road boundary features from the imagery. Moreover, extraction of the road features having occlusions or shadows from objects may be difficult.

It may be noted that the conventional systems may rely on hand-crafted feature extraction, that may work only in limited circumstances and may hardly cope with complicated road networks. Furthermore, the conventional systems may not honor a complete topology of the road features, such as the road boundary. Some conventional systems may be based on semantic segmentation models; however, such models may have inferior topology correctness, especially when road intersections or road merges/splits are encountered. The semantic segmentation models may have shortcomings with respect to instance awareness, road topological connectivity and completeness. The semantic segmentation models may perform pixel level classifications without awareness of the object instance as a complete entity. Thus, in such conventional systems, the detected road features may be fragmented, incomplete thereby making the feature data unreliable and inaccurate.

On the other hand, the system 100 of the present disclosure utilizes a combination of the complementary global feature segmentation model 104 and the local feature detection model 106 to generate the feature data. The global feature segmentation model 104 may be a segmentation model that may enable preservation of the topology of the road features, such as the road boundary and may provide better detection results for the road features. The local feature detection model 106 may attend a graph connection for the road features, that may provide better connectivity and completeness of the detected road features than the global feature segmentation model 104. Furthermore, the system 100 enables downscaling feature maps associated with the overhead image data 110A, to generate the feature data, thereby allowing reduced usage of memory and processing requirements. The reduced usage of the memory further enables co-training of the global feature segmentation model 104 and the local feature detection model 106, thereby making the system 100 efficient. Thus, usage of the combination of the global feature segmentation model 104 and the local feature detection model 106 makes the system 100 of the present disclosure accurate and reliable for generation of the enhanced quality feature data.

In operation, the mapping platform 102 may be configured to receive the overhead image data 110A from the imaging devices, such as the imaging device 111A and the imaging device 111B, that may be on board satellite 116 or the aerial vehicle 114 via the communication network 124. The overhead image data 110A may include, for example, top or oblique views of a road network and surrounding areas. The road network may include several roads that may have associated one or more road features. In an example, the one or more road features may include a road boundary of the road. In another example, the overhead image data 110A may be received from the content provider 112 or the services platform 120.

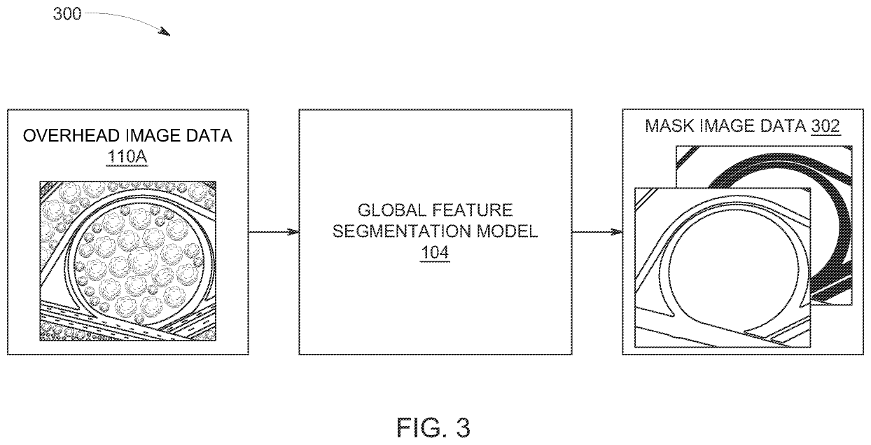

In some embodiments, the mapping platform 102 may be configured to generate mask image data based on application of the global feature segmentation model 104 on the overhead image data 110A. The global feature segmentation model 104 may process the overhead image data 110A to segment or extract the one or more road features (e.g., the road boundary) of the road from other components, such as the roads, buildings, trees, and so forth in the overhead image data 110A. Details of generation of the mask image data are further provided, for example, in FIG. 3.

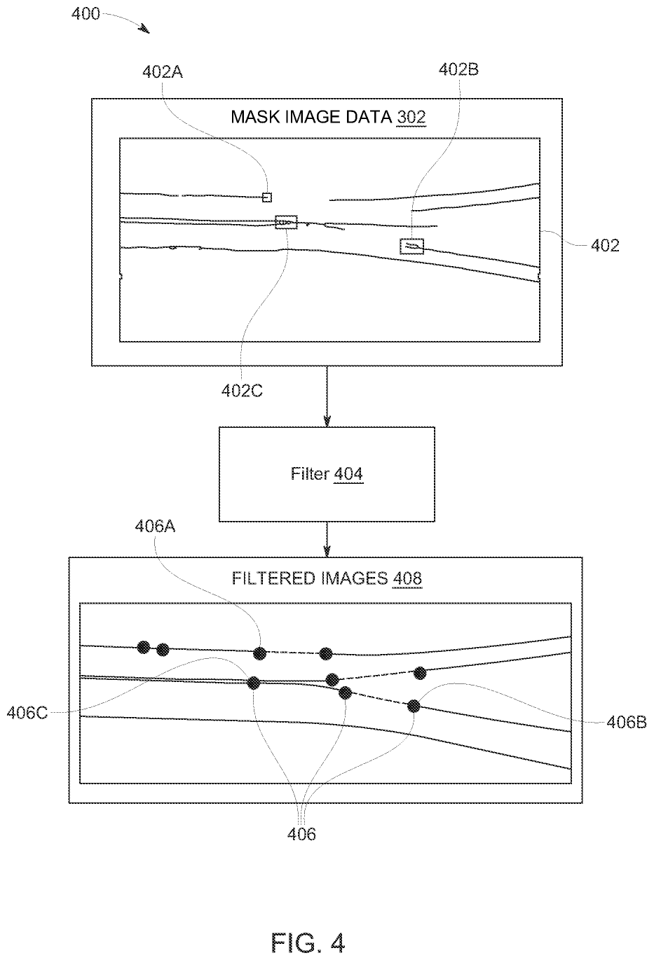

The mapping platform 102 may be configured to determine a set of break points associated with at least one road feature, based on mask image data. The extracted one or more road features in the mask image data may include discontinuities or breaks. Such discontinuities may need to be detected and may be included in the set of break points. In some embodiments, the mapping platform 102 may apply a filter on the mask image data to determine the set of break points. Details of determination of the set of break points are further provided, for example, in FIG. 4.

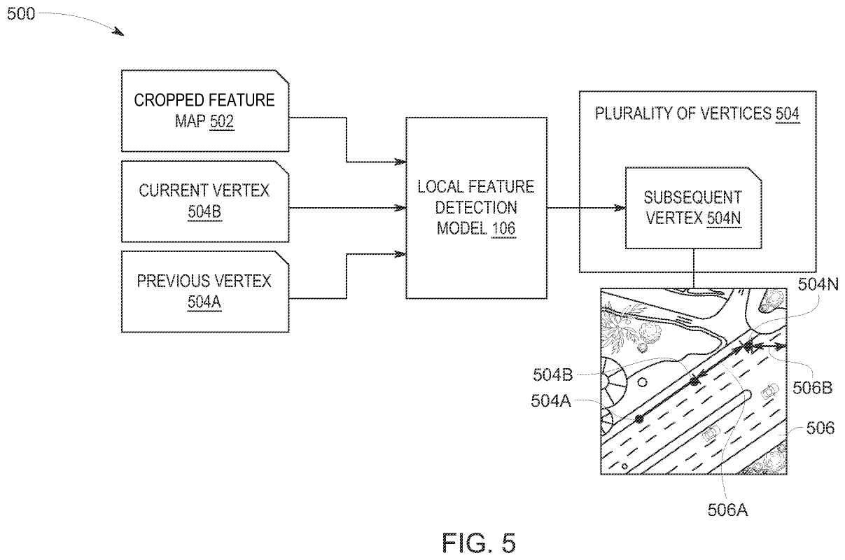

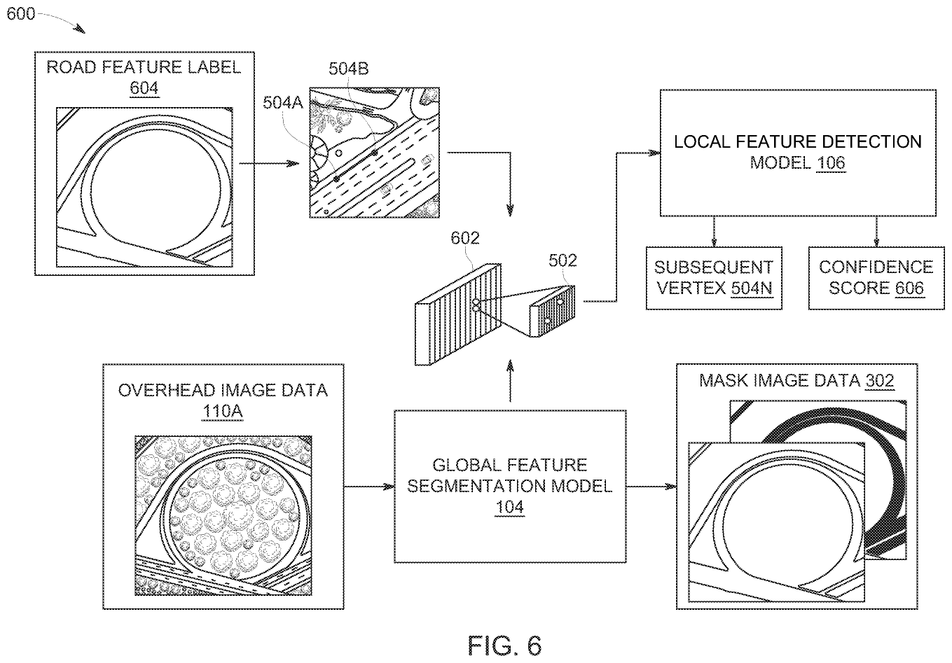

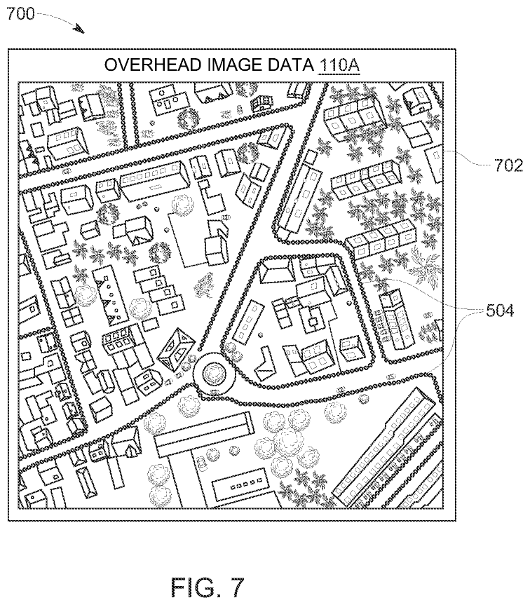

The mapping platform 102 may be configured to determine a plurality of vertices based on the determined set of break points. The plurality of vertices may be associated with the one or more road features included in the overhead image data 110A. The mapping platform 102 may utilize a global feature map obtained from the global feature segmentation model 104 to generate a set of cropped feature maps. The set of cropped feature maps along with the set of break points may be provided to the local feature detection model 106 to determine the plurality of vertices. Details of the determination of the plurality of vertices are further provided, for example, in FIG. 5, FIG. 6 and FIG. 7.

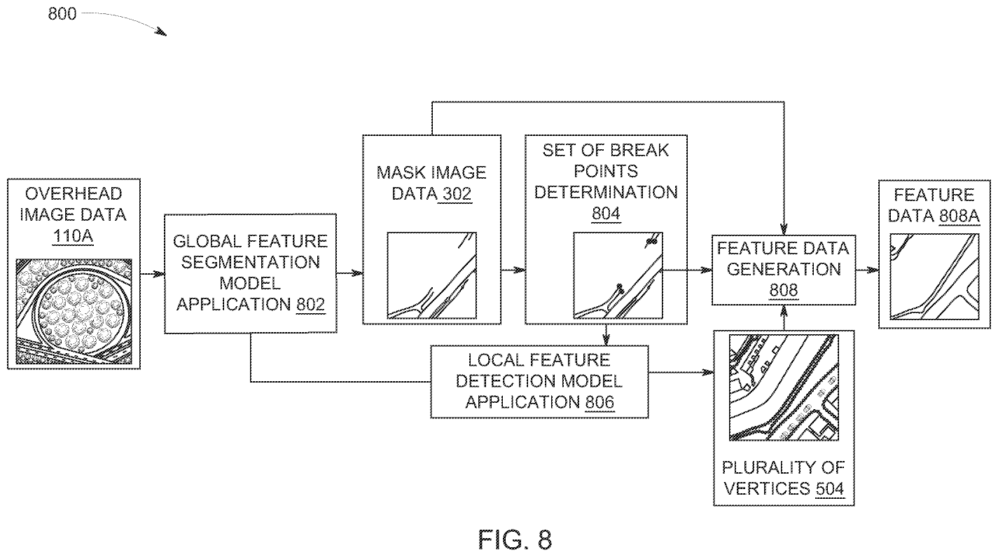

The mapping platform 102 may be configured to generate the feature data based on the output of the global feature segmentation model 104, i.e., the mask image data, and the output of the local feature detection model 106, i.e., the plurality of vertices. For example, the mapping platform 102 may cause to connect the plurality of vertices and combine the mask image data and the plurality of vertices, to generate the feature data. The feature data may further be stored in the geographic database 108. Details of the generation of the feature data are further provided, for example, in FIG. 8.

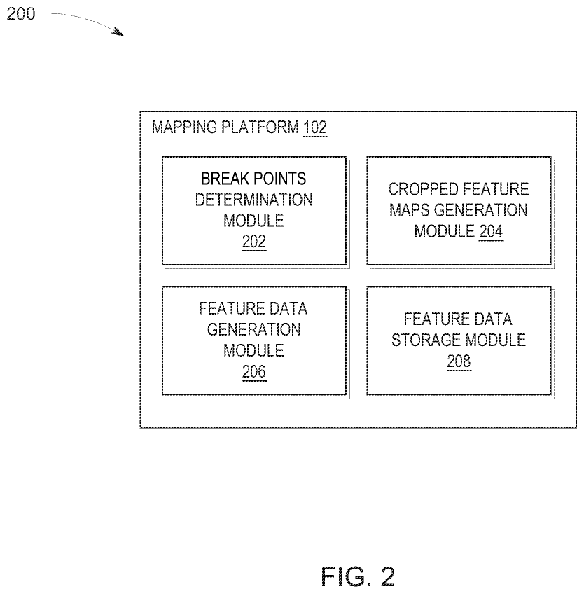

The components of the mapping platform 102 for generation of the feature data are described in FIG. 2.

FIG. 2 is a diagram of components of the mapping platform 102 capable of generating the feature data, according to one embodiment. In one embodiment, as shown in FIG. 2, the mapping platform 102 of the system 100 includes one or more components for generating the feature data according to the various embodiments described herein. It is contemplated that the functions of the components of the mapping platform 102 may be combined or performed by other components of equivalent functionality. As shown, in one embodiment, the mapping platform 102 includes a break points determination module 202, a cropped feature maps generation module 204, a feature data generation module 206 and a feature data storage module 208. The above presented modules and components of the mapping platform 102 can be implemented in hardware, firmware, software, or a combination thereof. Though depicted as a separate entity in FIG. 1, it is contemplated that the mapping platform 102 may be implemented as a module of any of the components of the system 100 (e.g., a component of the services platform 120, the content providers 122, the UE 116, the application 118, and/or the like). In another embodiment, one or more of the modules 202-208 may be implemented as a cloud-based service, local service, native application, or combination thereof. The functions of the mapping platform 102 and modules 202-208 are discussed with respect to the figures below.

FIG. 3 is a diagram 300 depicting generation of mask image data 302 by use of the global feature segmentation model 104, according to one embodiment. The diagram 300 may include the global feature segmentation model 104, the overhead image data 110A and the mask image data 302.

The overhead image data 110A may be utilized to generate the feature data associated with the at least one road feature of a road network. In some embodiments, the overhead image data 110A may include at least one of satellite imagery or aerial imagery. For example, the satellite imagery may be received from imaging devices on board the satellite 112 and the imaging devices on board the aerial vehicle 114 such as manned aerial vehicles and unmanned aerial vehicles (e.g., drones). The overhead image data 110A may include top or oblique views of a plurality of roads of the road network captured from various angles and height. In one or more embodiments, the overhead image data 110A may be received from sources, such as a server. The server may include overhead imagery of a plurality of geographical locations comprising the road network.

The overhead image data 110A received from the imaging devices on board the satellite 112 and the aerial vehicle 114, or the server may be stored in the geographic database 108. The overhead image data 110A may include multiple images of the plurality of roads having the at least one road feature. For example, the at least one road feature may include the road boundaries, lane markings, road centerlines, edge of the roads, sidewalks, pavements, road signs, and the like. The lane markings may represent lines or shapes corresponding to the road. Examples of the plurality of lane markings may include, but may not be limited to, road lane markings, traffic lane markings, highway lane markings, reversible lane markings, pavement arrows, edge lines of the road, and pavement markings.

In some embodiments, the mapping platform 102 may be configured to apply the global feature segmentation model 104 on the overhead image data 110A to generate the mask image data 302. For example, the overhead image data 110A may be provided as an input to the global feature segmentation model 104 to receive the mask image data 302 as an output. The global feature segmentation model 104 may be based on a global semantic feature segmentation network that may take as the overhead image data 110A as the input and output segmented road features, such as the road boundary and road surface masks as the mask image data 302.

In one or more embodiments, the global feature segmentation model 104 may include an encoder decoder deep learning architecture. For example, the encoder may be configured to transform the overhead image data 110A into various global feature maps or feature representations at different scales. The decoder may be configured to aggregate the various global feature maps from the different scales to provide, as the predicted output, the mask image data 302. Examples of the global feature segmentation model 104 include, but are not limited to, semantic segmentation networks and vision transformer-based models. Such models may be utilized for extraction of the road features from the input images, such as the overhead image data 110A and further post processing may be performed to receive the predicted mask image data 302 as the output. It may be noted that such models may have no awareness of topology correctness for the road features. Consequently, even though the output may be accurate, the mask image data 302 may include fragmented road features, such as fragmented road boundary sections, missing road boundaries, and interconnecting ones. In such cases, the output may be evaluated as having low connectivity and low completeness. In order to correct the fragmented road features to accurately determine the feature data, the mapping platform 102 may further process the mask image data 302 received from the global feature segmentation model 104. Details of processing the mask image data 302 are further provided, for example, in FIG. 4, FIG. 5 and FIG. 6.

FIG. 4 is a diagram 400 depicting determination of the set of break points, according to one embodiment. The diagram 400 may include a portion 402 of the mask image data 302, a filter 404 and a set of break points 406 included in a filtered image 408.

The mapping platform 102 may be configured to determine the set of break points 406 associated with the at least one road feature based on the mask image data 302. In an embodiment, the break points determination module 202 may be configured to determine the set of break points 406. The set of break points 406 may correspond to end points of the fragmented road features in the mask image data 302.

In some embodiments, the break points determination module 202 may apply the filter 404 on the mask image data 302. The set of break points 406 may be determined based on the application of the filter 404 on the mask image data 302. In an example, the filter 404 may be a kernel filter. The kernel filter may be a convolutional matrix that may be used for operations such as blurring, sharpening and edge detection from an image, such as the mask image data 302. The mapping platform 102 may utilize the filter 404 to determine the set of break points 406 in the segmented road feature, such as the road boundary in the mask image data 302.

In an embodiment, a kernel filtering technology may include applying convolution between the kernel (such as the convolutional matrix) and the mask image data 302 using a following equation:

$$g ( x , y ) = w * f ( x , y ) = {\sum }_{dx = - a}^{a} {\sum }_{dx = - b}^{b} f ( x - dx , y - dy ) \qquad ( 1 )$$

where g(x,y) is the filtered image 408, f(x,y) represents the mask image data 302 and w is the kernel.

For determination of the set of break points 406, the kernel w may be designed as:

$$[ \begin{matrix}1 & 1 & 1 \\ 1 & 10 & 1 \\ 1 & 1 & 1\end{matrix} ] \qquad ( 2 )$$

The filtered image 408 may include the set of break points 406. The set of break points 406 may further include one or more terminal points and one or more junction points (also referred as bifurcation points). The terminal point may be a point after which the road feature may be disconnected in the mask image data 302. For example, a break point 406A of the set of break points 406 corresponding to a region 402A in the mask image data 302 may be the terminal point. The junction point may be a point after which the road feature may bifurcate in the mask image data 302. For example, a break point 406B of the set of break points 406 corresponding to a region 402B in the mask image data 302 may be the junction point.

In an embodiment, some pixel values or locations in the filtered image 408 may be determined as the one or more terminal points or the one or more junction points. The pixel values may be obtained as the output of the kernel filter (i.e., g(x,y)). In an example, the pixel values in the filtered image 408 that may be equal to a certain value, e.g., “11” may be reported as the one or more terminal points. In another example, the pixel values in the filtered image 408 that may be equal to or more than a certain value, e.g., “12” may be reported as the one or more junction points. The one or more terminal points and the one or more junction points may further be ranked such that the one or more terminal points and the one or more junction points may be prioritized in completing data of the fragmented road features in the mask image data 302.

In some embodiments, the break points determination module 202 may be further configured to identify one or more break points of the set of break points 406 having a relative distance less than or equal to a first threshold distance. Based on the determination, the break points determination module 202 may combine the identified one or more break points. For example, there may be multiple break points determined in the filtered image 408 corresponding to a region 402C of the mask image data 302 as there are multiple discontinuities in the region 402C. However, the discontinuities may be close to each other, such that the relative distance between the multiple break points is less than the first threshold distance. In such a case, the multiple break points may be combined as a single break point, such as a break point 406C of the set of break points 406. In an embodiment, the first threshold distance may be 30 pixels, that may approximately be equal to a distance of 4 meters at a specific zoom level of the mask image data 302. In an example, the combination may be such that the single break point may be determined as a center break point of a cluster of the break points having the relative distance less than the first threshold distance.

FIG. 5 is a diagram 500 depicting determination of a plurality of vertices, according to one embodiment. The diagram 500 may include the local feature detection model 106. The diagram 500 may further include a cropped feature map 502 and a plurality of vertices 504.

The mapping platform 102 may further process the set of break points 406 and the cropped feature map 502 to determine the plurality of vertices 504. The mapping platform 102 may utilize the local feature detection model 106 to determine the plurality of vertices 504 in order to achieve connectivity and completeness fragmented road feature in the mask image data 302. In the local feature detection model 106, each instance of the road feature, such as the road boundary may be treated as an undirected graph consisting of the plurality of vertices 504 and their connecting edges.

In some embodiments, the local feature detection model 106 may correspond to a deep learning graph-based model. Thus, instead of classifying road boundary at image pixel level, the local feature detection model 106 may start at a current or a present vertex to predict image coordinates of a subsequent or a next vertex using the cropped feature map 502 corresponding to the overhead image data 110A. The mapping platform 102 may generate a cropped feature map for each vertex of the plurality of vertices 504. Thus, a set of cropped feature maps may be generated by the mapping platform 102. Details of generating the set of cropped feature maps are further provided, for example, in FIG. 6.

The mapping platform 102 may determine the plurality of vertices 504 starting from each break point of the set of break points 406. In some embodiments, the mapping platform 102 may select a first break point of the set of break points 406 as a current vertex or an initial vertex. The mapping platform 102 may further apply the local feature detection model 106 on the first break point (i.e., the current vertex) and a corresponding cropped feature map. The local feature detection model 106 may provide, as a predicted output, a subsequent vertex of the current vertex included in the plurality of vertices 504 and a confidence score associated with the subsequent vertex. The confidence score may be a value between 0 and 1. The higher the value of the confidence score, greater may be the accuracy of the prediction of the local feature detection model 106. Thus, in such a manner, the prediction or the determination of the plurality of vertices 504 may be initiated.

Furthermore, the local feature detection model 106 may be trained to infer the plurality of vertices 504 of the road boundary based on inputs from the cropped feature map 502, a current vertex 504B of the plurality of vertices 504, and a previous vertex 504A of the plurality of vertices 504. For example, the cropped feature map 502, the current vertex 504B and the previous vertex 504A may be provided as the input to the local feature detection model 106. The local feature detection model 106 may provide, as the predicted output, a subsequent vertex 504N of the plurality of vertices 504. In an example, a correspondence of the current vertex 504B, the previous vertex 504A and the subsequent vertex 504N with the road boundary is shown in an associated portion 506 of the overhead image data 110A. Details of application of the local feature detection model 106 are provided, for example, in FIG. 6.

In an embodiment, the plurality of vertices 504 may be determined until one or more stop conditions are met. The one or more stop conditions may include that a distance between the current vertex 504B and the previous vertex 504A is less than or equal to a second threshold distance. The current vertex 504B may be a latest or newest vertex output by the local feature detection model 106. Thus, in a latest iteration the subsequent vertex 504N may become the current vertex and the current vertex 504B may become the previous vertex. In such a case, a distance 506A between the subsequent vertex 504N and the current vertex 504B may be determined. In case, if the distance 506A is less than or equal to the second threshold distance, the determination of the plurality of vertices 504 may be stopped. In an example, the second threshold distance may be 5 pixels.

The one or more stop conditions may further include that a distance between the current vertex 504B and an end point of a corresponding cropped feature map that corresponds to a boundary of the overhead image data 110A is less than or equal to a third threshold distance. In the latest iteration, the subsequent vertex 504N may become the current vertex 504B. A distance 506B is shown as the distance between the current vertex 504B and the end point of the corresponding cropped feature map. The portion 506 of the overhead image data 110A may correspond to the cropped feature map. Thus, when the distance 506B is less than or equal to the third threshold distance, the determination of the plurality of vertices 504 may be stopped. In an example, the third threshold distance may be 5 pixels. For example, in case the overhead image data 110A is of size 1280×1280 pixels, the distance 506B may be considered as less than or equal to 5 pixels or more than 1275 pixels. In some embodiments, values of the second threshold distance and the third threshold distance may differ for the linear features having a substantially straight geometry and for the linear features having a substantially curved geometry. Once the one or more stop conditions are met for the first break point of the set of break points 406, the process may start for a second break point of the set of break points 406.

FIG. 6 is a diagram 600 depicting usage of the cropped feature map for the determination of the plurality of vertices 504, according to one embodiment. The diagram 600 may include the global feature segmentation model 104, the local feature detection model 106, the overhead image data 110A, the mask image data 302, the cropped feature map 502 and the plurality of vertices 504. The diagram 600 may further include a global feature map 602, a road feature label 604 and a confidence score 606 received as the output of the local feature detection model 106.

In an embodiment, the local feature detection model 106 may only require data containing image information describing a local context region surrounding a current vertex location, such as the current vertex 504B as the input. For example, the local context region may be a region including some portion ahead and behind the current vertex 504B, such that the local feature detection model 106 is able to predict the subsequent vertex 504N in the region ahead the current vertex 504B. Thus, instead of using the overall overhead image data 110A, the local feature detection model 106 may require only a cropped portion of the overhead image data 110A that may correspond to the current vertex 504B.

In an embodiment, the local feature detection model 106 may be configured to generate a cropped feature map corresponding to the cropped portion of the overhead image data 110A that may correspond to the current vertex 504B. Thus, the set of cropped feature maps may be generated for the plurality of vertices 504. However, generation of the set of cropped feature maps by the local feature detection model 106 using the overhead image data 110A may be computationally exhaustive.

It may be noted that in order to generate the mask image data 302, the encoder decoder architecture of the global feature segmentation model 104 may be configured to generate the global feature map 602. The global feature map 602 may represent one or more features of an image, such as the overhead image data 110A. Thus, the global feature map 602 received from the global feature segmentation model 104 may be utilized to generate the set of cropped feature maps. In an example, a size of the set of cropped feature maps may be 64×64×3 pixels. In such a manner, a requirement of an additional encoder decoder architecture in the local feature detection model 106 may be eliminated. Moreover, time-consuming and computation intensive encoding phase only needs to be executed once in the global feature segmentation model 104 to largely save computational resources and cost of the overall system.

In some embodiments, the mapping platform 102 may be configured to upsample the global feature map 602 to match the size of the overhead image data 110A in a decoder arm of the global feature segmentation model 104. For example, when aggregating multiple deep learning feature maps along the decoder arm or path of the global feature segmentation model 104, the multiple feature maps from 1/32 scale, 1/16 scale, ⅛ scale, and ¼ scale may be upsampled and combined with higher-level feature maps iteratively until reaching a ¼ scale level for the feature map. Moreover, a final upsampling equivalent operation may be used to convert the ¼ scale feature map back to a same size as the overhead image data 110A. For example, when the overhead image data 110A is of size 1280×1280×3 pixels, the global feature map 602 tensor is of size 1280×1280×32 pixels.

The mapping platform 102 may further determine the region associated with each of the set of break points 406 in the upsampled global feature map 402. For example, for each of the break point, the local context region may be the determined region including some portion ahead and behind each of the set of break points 406. The mapping platform 102 may generate the set of cropped feature maps by extracting the corresponding region for each of the set of break points 406 from the upsampled global feature map 402. For example, each set of cropped feature maps may be a local feature map tensor of size 64×64×32 pixels.

In one or more embodiments, the mapping platform 102 may be configured to downsample the set of cropped feature maps. The mapping platform 102 may further apply the local feature detection model 106 on the current vertex 504B and a corresponding cropped feature map 502 of the downsampled set of cropped feature maps to determine the plurality of vertices 504. For example, the cropped feature map (such as a local attention feature representation) may be cropped in the ¼ scale to obtain an equivalent local attention feature representation size of 16×16×32 pixels. Thus, the local feature detection model 106 may be applied to the downsampled feature cropped feature map that may be only 1/16 size of the original cropped feature map without information loss. Such a result may be achieved by detecting a corresponding tensor region in the ¼ scale aggregated cropped feature map while centering at a location corresponding to the location of the current vertex 504B in the ¼ scaled cropped feature map. Such a method enables co-model training and inference for the joint global feature segmentation model 104 and the local feature detection model 106.

In some embodiments, a number of previous vertices of the plurality of vertices 504 to be fed to the local feature detection model 106 may depend on a geometry of the road feature in the corresponding cropped feature map. The mapping platform 102 may be configured to determine that a portion of the at least one road feature in a region included in the cropped feature map 502 is associated with a substantially straight geometry. For example, when the local attention region may be small, and a curvature of the linear feature, such as the road boundary may be smooth. In an embodiment, the mapping platform 102 may determine the substantially straight geometry based on a geometry threshold. For example, when a curvature or a turning angle associated with the linear feature is less than the geometry threshold, the substantially straight geometry may be determined. The cropped feature map 502 may be associated with the current vertex 504B received as the predicted output from the local feature detection model 106. In an example, the road feature may be the road boundary. The road boundary in the region included in the cropped feature map 502 may be substantially straight (i.e., almost curve less). In such a case, the mapping platform 102 may iteratively apply the local feature detection model 106 on a previous vertex, such as the previous vertex 504A received as the predicted output, the current vertex 504B and the corresponding cropped feature map 502 associated with the current vertex 504B, until the one or more stop conditions are met. The mapping platform 102 may receive, as the predicted output of the local feature detection model 106, the determined plurality of vertices 504, along with the confidence score 606 for each of the plurality of vertices 504. Thus, for road features, such as the road boundary detections, the local feature detection model 106 may take only two known vertices, i.e., the current vertex and the previous vertex, to make the subsequent vertex prediction. Such a process may be effective as coordinates of the previous vertex and current vertex may include direction information to guide the subsequent vertex prediction.

In some embodiments, the mapping platform 102 may be configured to determine that the portion of the at least one road feature in the region included in the cropped feature map 502 is associated with a substantially curved geometry. For example, when the curvature (or the turning angle) of the linear feature, such as the road boundary may be large. In some embodiments, when the curvature or the turning angle associated with the linear feature is more than or equal to the geometry threshold, the substantially curved geometry may be determined. In an example, the road feature may be the road boundary. The road boundary in the region included in the cropped feature map 502 may be substantially curved (e.g., having more than a 10 degree turn). In such a case, the mapping platform 102 may iteratively apply the local feature detection model 106 on a set of previous vertices received as the predicted output, the current vertex 504B and the corresponding cropped feature map 502 associated with the current vertex 504B, until the one or more stop conditions are met. In an example, a windowed sequence of the set of previous vertices (i.e., the vertices in t−1, t−2, . . . , t−n steps) and the current vertex 504B (i.e., the vertex at t step) may be fed to the local feature detection model 106. For example, a window size of the set of previous vertices may be 5. The window size may vary based on various parameters, such as an amount of curvature, a type of road, and the like. The mapping platform 102 may receive, as the predicted output of the local feature detection model 106, the determined plurality of vertices 504, along with the confidence score 606 for each of the plurality of vertices 504.

In some embodiments, the road feature label 604 may be a label that may be provided to the local feature detection model 106 to determine the plurality of vertices 504. In an example, the road feature label 604 may correspond to a label “road boundary”. The road feature label 604 may be utilized by the local feature detection model 106 to identify the type of road feature for which the plurality of vertices 504 needs to be determined.

In a nutshell, the mapping platform 102 may first receive the global feature map 602 from the global feature segmentation model 104. The global feature map 602 may be upsampled to match the size of the overhead image data 110A. The mapping platform 102 may further generate the cropped feature map 502 corresponding to the current vertex 504B from the global feature map 602. The global feature map 602 may be downscale to the cropped feature map 502. The mapping platform 102 may provide the current vertex 504B, the previous vertex 504A, the cropped feature map 502 and the road feature label 604 to the local feature detection model 106 to determine the subsequent vertex 504N of the plurality of vertices 504. The local feature detection model 106 may further output the confidence score associated with the subsequent vertex 504N. Exemplary determined plurality of vertices 504 are further shown in FIG. 7.

FIG. 7 is a diagram 700 depicting the determined plurality of vertices 504 associated with an overhead image data, according to one embodiment. The diagram 700 may include a portion 702 of the overhead image data 110A and the plurality of vertices 504. The mapping platform 102 may determine the plurality of vertices 504 that may correspond to the road feature, such as the road boundary as shown. The plurality of vertices 504 are superimposed on the portion 702 of the overhead image data 110A to depict a correspondence of the plurality of vertices 504 and the road feature included in the overhead image data 110A. The plurality of vertices 504 may be utilized to accurately connect the discontinuities that were observed in the mask image data 302 output from the global feature segmentation model 104. The combination of the output of the global feature segmentation model 104, i.e., the mask image data 302 and the output of the local feature detection model 106, i.e., the plurality of vertices 504 is described in FIG. 8.

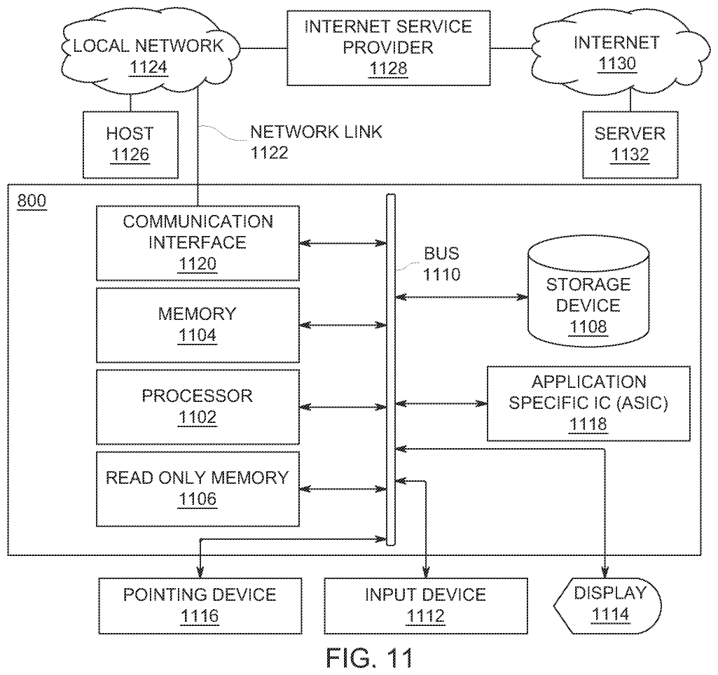

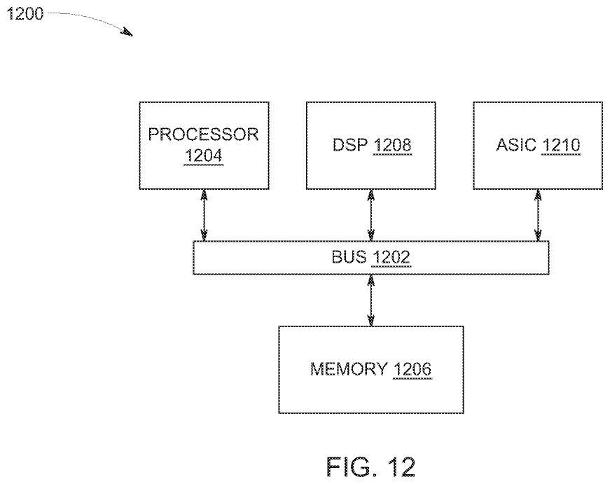

FIG. 8 is a diagram of a method 800 depicting usage of the mask image data 302 and the plurality of vertices 504 to generate the feature data, according to one embodiment. In various embodiments, the mapping platform 102 and/or any of the modules 202-208 may perform one or more portions of the method 800 and may be implemented in, for instance, a chip set including a processor and a memory as shown in FIG. 11 and FIG. 12. As such, the mapping platform 102 and/or any of the modules 202-208 may provide means for accomplishing various parts of the method 800, as well as means for accomplishing embodiments of other processes described herein in conjunction with other components of the system 100. Although the method 800 is illustrated and described as a sequence of steps, it is contemplated that various embodiments of the method 800 may be performed in any order or combination and need not include all of the illustrated steps.

At step 802, the global feature segmentation model 104 may be applied to the overhead image data 110A. The mapping platform 102 may apply the global feature segmentation model 104 on the overhead image data 110A to generate the mask image data 302. Details of generation of the mask image data 302 are further provided, for example, in FIG. 3.

At step 804, the set of break points 406 may be determined. The mapping platform 102 may apply the filter 404 on the mask image data 302 to determine the set of break points 406. For example, the filter 404 may be the kernel filter. Details of determination of the set of break points 406 are further provided, for example, in FIG. 4.

At step 806, the local feature detection model 106 may be applied. The mapping platform 102 may utilize the cropped feature maps and the set of break points 406 to determine the plurality of vertices 504. In an embodiment, the mapping platform 102 may utilize the global feature map 602 to generate the cropped feature maps. The local feature detection model 106 may be applied on the current predicted vertex and the previous vertices of the plurality of vertices 504, along with the cropped feature maps to determine the subsequent vertices of the plurality of vertices 504. Details of determination of the plurality of vertices 504 are further provided, for example, in FIG. 5, FIG. 6 and FIG. 7.

At step 808, feature data 808A associated with the at least one road feature may be generated. In some embodiments, the feature data generation module 206 may be configured to generate the feature data 808A. The feature data 808A may be generated based on the application of the local feature detection model 106 on the generated set of cropped feature maps and the set of break points 406.

In some embodiments, to generate the feature data 808A, the mapping platform 102 may combine the generated mask image data 302 and the determined plurality of vertices 504. In an example, a fusion module of the mapping platform 102 may be configured to combine the generated mask image data 302 and the determined plurality of vertices 504. The mapping platform 102 may merge overlapping vertices of the determined plurality of vertices 504. For example, some vertices may overlap, as for each break point, the vertices may be determined. In such a case, the overlapping vertices may be merged. Furthermore, the mapping platform 102 may connect vertices of the determined plurality of vertices 504 having a distance less than or equal to a fourth threshold distance. In an example, the fourth threshold distance may be less than or equal to 30 pixels. Thus, the plurality of vertices 504 having the distance less than or equal to 30 pixels may be connected. In such a manner, the road feature, such as the road boundary may be completed in the mask image data 302.

Furthermore, the mapping platform 102 may be configured to store the generated feature data 808A in the geographic database 108. In an embodiment, the feature data storage module 208 may be configured to store the feature data 808A in the geographic database 108. In some embodiments, the feature data 808A may be stored as new data associated with the at least one road feature included in the overhead image data 110A. In one or more embodiments, the feature data 808A may be utilized to update previously stored feature data associated with the at least one road feature included in the overhead image data 110A in the geographic database 108. Additionally, the feature data 808A may be transmitted to a client database over the communication network 124. For example, the client database may be associated with a map service provider that may utilize the feature data 808A to generate maps.

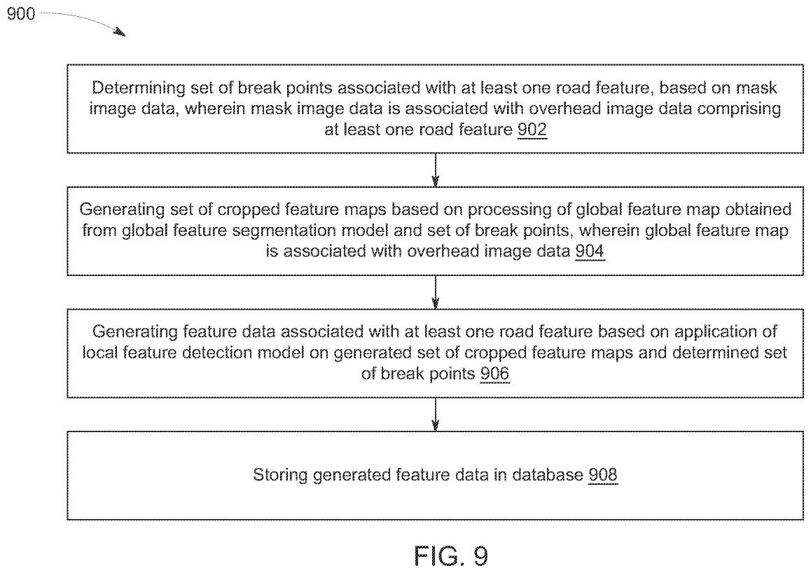

FIG. 9 is a flowchart of a method 900 for generating the feature data 808A, according to one embodiment. In various embodiments, the mapping platform 102 and/or any of the modules 202-208 may perform one or more portions of the method 800 and may be implemented in, for instance, a chip set including a processor and a memory as shown in FIG. 11 and FIG. 12. As such, the mapping platform 102 and/or any of the modules 202-208 may provide means for accomplishing various parts of the method 800, as well as means for accomplishing embodiments of other processes described herein in conjunction with other components of the system 100. Although the method 800 is illustrated and described as a sequence of steps, it is contemplated that various embodiments of the method 800 may be performed in any order or combination and need not include all of the illustrated steps.

At step 902, the set of break points 406 may be determined. In some embodiments, the break points determination module 202 may be configured to determine the set of break points 406 associated with the at least one road feature based on the mask image data 302. The mask image data 302 may be associated with the overhead image data 110A that includes the at least one road feature. Details of determination of the set of break points 406 are further provided, for example, in FIG. 4.

At step 904, the set of cropped feature maps may be generated. In some embodiments, the cropped feature maps generation module 204 may be configured to generate the set of cropped feature maps. The set of cropped feature maps may be generated based on the processing of the global feature map 602 associated with the overhead image data 110A obtained from the global feature segmentation model 104, and the set of break points 406. Details of generation of the set of cropped feature maps are further provided, for example, in FIG. 6.

At step 906, the feature data 808A may be generated. In some embodiments, the feature data generation module 206 may be configured to generate the feature data 808A associated with the at least one road feature based on the application of the local feature detection model 106 on the generated set of cropped feature maps and the set of break points 406. Details of generation of the feature data 808A are further provided, for example, in FIG. 8.

At step 908, the feature data 808A may be stored. In some embodiments, the feature data storage module 208 may be configured to store the feature data 808A in the geographic database 108. Details of storage of the feature data 808A are further provided, for example, in FIG. 8.

Returning to FIG. 1, as shown, the system 100 includes the mapping platform 102 for generation of the feature data 808A. The services platform 120 may include one or more services, such as a service 120A and a service 120N. The content providers 122 may further include one or more content providers, such as a content provider 122A and a content provider 122M.

The global feature segmentation model 104 may be a segmentation model that may enable preservation of the topology of the road features, such as the road boundary and may provide better detection results for the road features. The global feature segmentation model 104 may include the encoder decoder architecture. In an example, the global feature segmentation model 104 may have 7×7 convolution layers and a number of residual blocks of the neural network. The global feature segmentation model 104 may further include pooling layers as part of the neural network. Examples of the global feature segmentation model 104 include, but are not limited to, semantic segmentation networks and vision transformer based models. Such models may be utilized for extraction of the road features from the input images, such as the overhead image data 110A. For example, the global feature segmentation model 104 may be U-Net®, DeepLab® and D-LinkNet®.

The local feature detection model 106 may attend a graph connection for the road features, that may provide better connectivity and completeness of the detected road features than the global feature segmentation model 104. In some embodiments, the local feature detection model 106 may correspond to a deep learning graph-based model. In an example, the local feature detection model 106 may be a convolutional neural network with a number of convolution layers, pooling layers and fully connected layers.

In one embodiment, the mapping platform 102 has connectivity over the communication network 124 to the services platform 120 that provides the one or more services, such as the service 120A and the service 120N that can use the generated feature data 808A for downstream functions. By way of example, the service 120A and the service 120N may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the service 120A and the service 120N uses the output of the mapping platform 102 (e.g., the feature data 808A stored in the geographic database 108, maps stored in the geographic database 108, etc.) to provide services such as navigation, mapping, other location-based services, etc. to the UE 116, the applications 118, and/or other client devices. In one embodiment, the service platform 120 may act as a content provider, analogously to content provider 122A, providing the overhead image data 110A to the mapping platform 102, either directly or via the overhead image database 110. In some embodiments, the overhead image database 110 may also be one of the content providers 122 or the services platform 120.

In one embodiment, the mapping platform 102 may be a platform with multiple interconnected components. The mapping platform 102 may include multiple servers, intelligent networking devices, computing devices, components, and corresponding software for generation of the feature data 808A according to the various embodiments described herein. In addition, it is noted that the mapping platform 102 may be a separate entity of the system 100, a part of the service 120A and the service 120N, a part of the services platform 120, or included within components of the UE 116.

In one embodiment, the content providers 122 may provide content or data (e.g., the overhead image data 110A, probe data, related geographic data, etc.) to the geographic database 108, the mapping platform 102, the services platform 120, the service 120A and the service 120N, the UE 116, and/or the applications 118 executing on the UE 116. The content provided may be any type of content, such as overhead image data 110A, sensor data, imagery, probe data, machine learning models, permutations matrices, map embeddings, map content, textual content, video content, image content, etc., for example, obtained via the satellite 112 or the aerial vehicle 114. In one embodiment, the content providers 122 may provide content that may aid in generation of the feature data 808A according to the various embodiments described herein. In one embodiment, the content providers 122 may also store content associated with the geographic database 108, the mapping platform 102, the services platform 120, the service 120A and the service 120N, and/or any other component of the system 100. In another embodiment, the content providers 122 may manage access to a central repository of data, and offer a consistent, standard interface to data, such as a repository of the geographic database 108.

In one embodiment, the UE 116 may execute software applications 118 to use the feature data 808A or other data derived therefrom according to the embodiments described herein. By way of example, the applications 118 may also be any type of application that is executable on the UE 116, such as autonomous driving applications, routing applications, mapping applications, location-based service applications, navigation applications, device control applications, content provisioning services, camera/imaging application, media player applications, social networking applications, calendar applications, and the like. In one embodiment, the applications 118 may function as a client for the mapping platform 102 and perform one or more functions associated with generation of the feature data 808A alone or in combination with the mapping platform 102.

By way of example, the UE 116 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 116 can support any type of interface to the user (such as “wearable” circuitry, etc.). In one embodiment, the UE 116 may be associated with or be a component of a vehicle or any other device.

In one embodiment, the UE 116 is configured with various sensors for generation of the overhead image data 110A, related geographic data, etc. In one embodiment, the overhead image data 110A represent data associated with a geographic location or coordinates at which sensor data was collected, and the polyline or polygonal representations of detected objects of interest derived therefrom to generate the digital map data of the geographic database 108. By way of example, the sensors may include a global positioning sensor for gathering location data (e.g., GPS, GALILEO, BEIDOU, GLONASS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the UE 116 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the UE 116 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 116 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 124 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 102, the services platform 120, the service 120A and the service 120N, the UE 116, and/or the content providers 122 communicate with each other and other components of the system 100 using well known, new or still developing protocols. In this context, a protocol includes a set of rules defining how the network nodes within the communication network 124 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

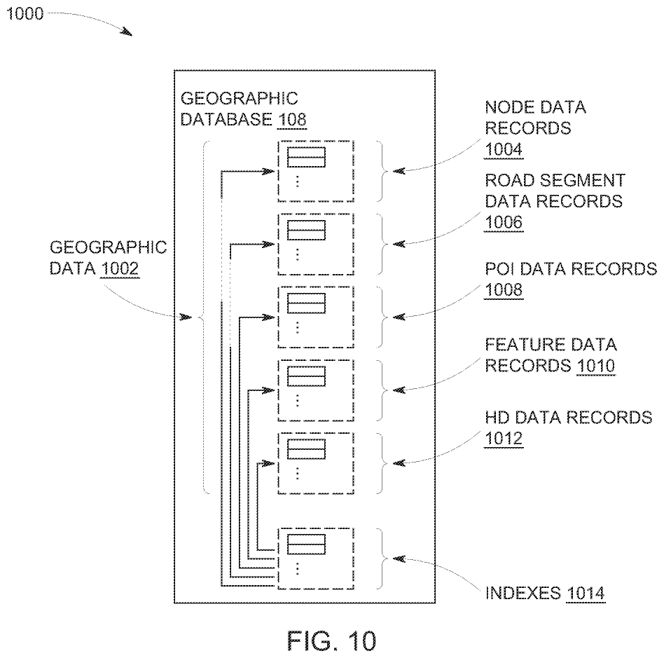

FIG. 10 is a diagram of the geographic database 108, according to one embodiment. In one embodiment, the geographic database 108 includes geographic data 1002 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1002. In one embodiment, the geographic database 108 includes high definition (HD) mapping data that provide centimeter-level or better accuracy of map features. For example, the geographic database 108 can be based on Light Detection and Ranging (LiDAR) or equivalent technology to collect billions of 3D points and model road surfaces and other map features down to the number lanes and their widths. In one embodiment, the HD mapping data (e.g., HD data records 1012) and/or other mapping data of the geographic database 108 capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 108.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 108 follows certain conventions. For example, links do not cross themselves and do not cross each other except at a node. Also, there are no duplicated shape points, nodes, or links. Two links that connect each other have a common node. In the geographic database 108, overlapping geographic features are represented by overlapping polygons. When polygons overlap, the boundary of one polygon crosses the boundary of the other polygon. In the geographic database 108, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 108 includes node data records 1004, road segment or link data records 1006, POI data records 1008, feature data records 1010, HD mapping data records 1012, and indexes 1014, for example. In some examples, the feature data 808A that may include the data of the features such as the road boundaries, the centerlines, the sidewalks, the lane markings, and the like may be stored as the node data records 1004, the road segment or the link data records 1006, the POI data records 1008, the feature data records 1010, the HD mapping data records 1012, and the indexes 1014. More, fewer, or different data records can be provided. In some embodiments, the feature data records 1010 may be stored in the geographic database 108. In one embodiment, additional data records (not shown) can include cartographic (“carto”) data records, routing data, and maneuver data. In one embodiment, the indexes 1014 may improve the speed of data retrieval operations in the geographic database 108. In one embodiment, the indexes 1014 may be used to quickly locate data without having to search every row in the geographic database 108 every time it is accessed. For example, in one embodiment, the indexes 1014 can be a spatial index of the polygon points associated with stored feature polygons. In one or more embodiments, data of a data record may be attributes of another data record.

In exemplary embodiments, the road segment data records 1006 are links or segments representing roads, streets, paths, or bicycle lanes, as can be used in the calculated route or recorded route information for determination of speed profile data. The node data records 1004 are end points (for example, representing intersections or an end of a road) corresponding to the respective links or segments of the road segment data records 1006. The road segment data records 1006 and the node data records 1004 represent a road network, such as used by vehicles, cars, and/or other entities. Alternatively, the geographic database 108 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 108 can include data about the POIs and their respective locations in the POI data records 1008. The geographic database 108 can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or map feature data can be part of the POI data records 708 or can be associated with POIs or POI data records 1008 (such as a data point used for displaying or representing a position of a city).

In one embodiment, the geographic database 108 can also include the feature data records 1010 for storing the feature data 808A, and/or any other related data that is used or generated according to the embodiments described herein. By way of example, the feature data records 1010 can be associated with one or more of the node records 1004, the road segment records 1006, and/or the POI data records 1008 to associate the speed profile data records with specific places, POIs, geographic areas, and/or other map features. In this way, the linearized data records can also be associated with the characteristics or metadata of the corresponding records 1004, 1006, and/or 1008.

In one embodiment, as discussed above, the HD mapping data records 1012 model road surfaces and other map features to centimeter-level or better accuracy. The HD mapping data records 1012 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1012 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1012 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1012.

In one embodiment, the HD mapping data records 1012 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 108 can be maintained by the content provider 122 in association with the mapping platform 102 (e.g., a map developer or service provider). The map developer can collect geographic data to generate and enhance the geographic database 108. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 108 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicle and/or the UE 116. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for generating the feature data 808A may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 11 is a diagram of hardware that can be used to implement an embodiment. Computer system 1100 is programmed (e.g., via computer program code or instructions) for generating the feature data 808A as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

The bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to generation of the feature data 808A. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

The computer system 1100 also includes a memory 1104 coupled to bus 1110. The memory 1104, such as a random access memory (RAM) or other dynamic storage device, stores information including processor instructions for generating the feature data 808A. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, which is not changed by the computer system 1100. Some memory is composed of volatile storage that loses the information stored thereon when power is lost. Also coupled to the bus 1110 is a non-volatile (persistent) storage device 1108, such as a magnetic disk, optical disk, or flash card, for storing information, including instructions, which persists even when the computer system 1100 is turned off or otherwise loses power.

Information, including instructions for generating the feature data 808A, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1118, is coupled to the bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1100 also includes one or more instances of a communications interface 1120 coupled to bus 1110. The communication interface 1120 provides a one-way or two-way communication coupling to a variety of external devices that operate with their own processors, such as printers, scanners, and external disks. In general, the coupling is with a network link 1122 that is connected to a local network 1124 to which a variety of external devices with their own processors are connected. For example, the communication interface 1120 may be a parallel port or a serial port or a universal serial bus (USB) port on a personal computer. In some embodiments, communications interface 1120 is an integrated services digital network (ISDN) card or a digital subscriber line (DSL) card or a telephone modem that provides an information communication connection to a corresponding type of telephone line. In some embodiments, the communication interface 1120 is a cable modem that converts signals on the bus 1110 into signals for a communication connection over a coaxial cable or into optical signals for a communication connection over a fiber optic cable. As another example, communications interface 1120 may be a local area network (LAN) card to provide a data communication connection to a compatible LAN, such as Ethernet. Wireless links may also be implemented. For wireless links, the communications interface 1120 sends or receives or both sends and receives electrical, acoustic, or electromagnetic signals, including infrared and optical signals, which carry information streams, such as digital data. For example, in wireless handheld devices, such as mobile telephones like cell phones, the communications interface 1120 includes a radio band electromagnetic transmitter and receiver called a radio transceiver. In certain embodiments, the communications interface 1120 enables connection to the communication network 126 for generating the feature data 808A.

The term computer-readable medium is used herein to refer to any medium that participates in providing information to processor 1102, including instructions for execution. Such a medium may take many forms, including, but not limited to, non-volatile media, volatile media, and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1122 typically provides information communication using transmission media through one or more networks to other devices that use or process the information. For example, the network link 1122 may provide a connection through local network 1124 to a host computer 1126 or to equipment 1128 operated by an Internet Service Provider (ISP). ISP equipment 1128 in turn provides data communication services through the public, world-wide packet-switching communication network of networks now commonly referred to as the Internet 1130.

A computer called a server host 1132 connected to the Internet hosts a process that provides a service in response to information received over the Internet. For example, server host 1132 hosts a process that provides information representing video data for presentation at display 1114. It is contemplated that the components of system can be deployed in various configurations within other computer systems, e.g., host 1126 and server 1132.

FIG. 12 is a diagram of a chip set 1200 that can be used to implement an embodiment. The chip set 1200 is programmed to generate the feature data 808A as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1202 for passing information among the components of the chip set 1200. A processor 1204 has connectivity to the bus 1202 to execute instructions and process information stored in, for example, a memory 1206. The processor 1204 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1204 may include one or more microprocessors configured in tandem via the bus 1202 to enable independent execution of instructions, pipelining, and multithreading. The processor 1204 may also be accompanied with one or more specialized components to perform certain processing functions and tasks such as one or more digital signal processors (DSP) 1208, or one or more application-specific integrated circuits (ASIC) 1210. A DSP 1208 typically is configured to process real-world signals (e.g., sound) in real time independently of the processor 1204. Similarly, an ASIC 1210 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1204 and accompanying components have connectivity to the memory 1206 via the bus 1202. The memory 1206 includes both dynamic memory (e.g., RAM, magnetic disk, writable optical disk, etc.) and static memory (e.g., ROM, CD-ROM, etc.) for storing executable instructions that when executed perform the inventive steps described herein to generate the feature data 808A. The memory 1206 also stores the data associated with or generated by the execution of the inventive steps.

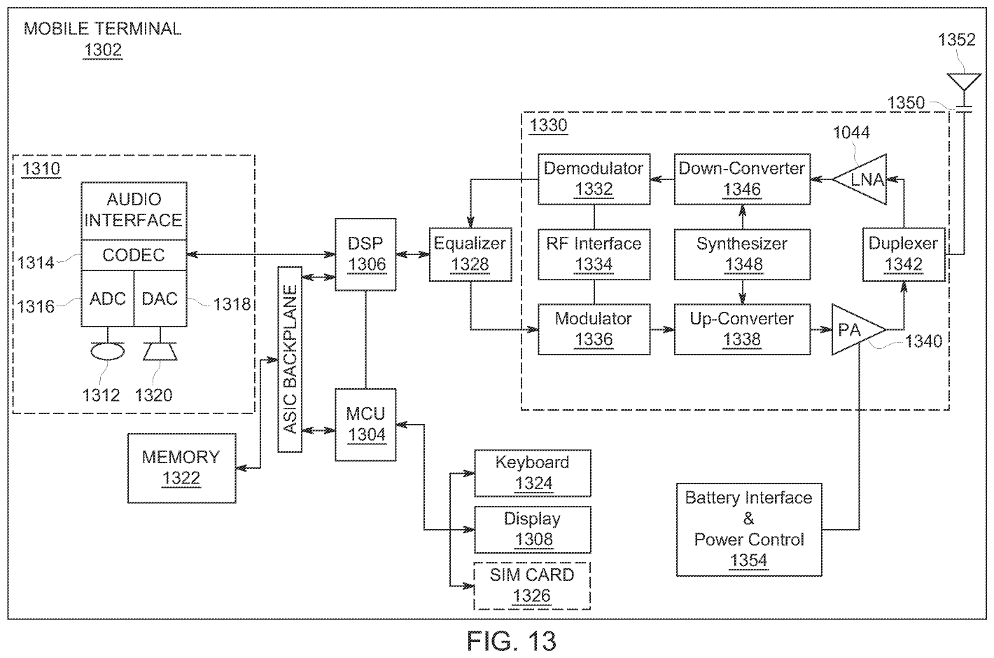

FIG. 13 is a diagram of a mobile terminal 1302 (e.g., handset, vehicle, or part thereof) that can be used to implement an embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1304, a Digital Signal Processor (DSP) 1306, and a receiver/transmitter unit including a microphone gain control unit and a speaker gain control unit. A main display unit 1308 provides a display to the user in support of various applications and mobile station functions that offer automatic contact matching. An audio function circuitry 1310 includes a microphone 1312 and microphone amplifier that amplifies the speech signal output from the microphone 1312. The amplified speech signal output from the microphone 1312 is fed to a coder/decoder (CODEC) 1314.

A radio section 1330 amplifies power and converts frequency in order to communicate with a base station, which is included in a mobile communication system, via antenna 1352. The power amplifier (PA) 1340 and the transmitter/modulation circuitry are operationally responsive to the MCU 1004, with an output from the PA 1340 coupled to the duplexer 1342 or circulator or antenna switch, as known in the art. The PA 1340 also couples to a battery interface and power control unit 1354.

In use, a user of mobile station 1302 speaks into the microphone 1312 and his or her voice along with any detected background noise is converted into an analog voltage. The analog voltage is then converted into a digital signal through the Analog to Digital Converter (ADC) 1316. The control unit 1304 routes the digital signal into the DSP 1306 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (Wi-Fi), satellite, and the like.

The encoded signals are then routed to an equalizer 1328 for compensation of any frequency-dependent impairments that occur during transmission though the air such as phase and amplitude distortion. After equalizing the bit stream, the modulator 1336 combines the signal with an RF signal generated in the RF interface 1334. The modulator 1336 generates a sine wave by way of frequency or phase modulation. In order to prepare the signal for transmission, an up-converter 1338 combines the sine wave output from the modulator 1336 with another sine wave generated by a synthesizer 1348 to achieve the desired frequency of transmission. The signal is then sent through a PA 1340 to increase the signal to an appropriate power level. In practical systems, the PA 1340 acts as a variable gain amplifier whose gain is controlled by the DSP 1306 from information received from a network base station. The signal is then filtered within the duplexer 1342 and optionally sent to an antenna coupler 1350 to match impedances to provide maximum power transfer. Finally, the signal is transmitted via antenna 1352 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1302 are received via antenna 1352 and immediately amplified by a low noise amplifier (LNA) 1344. A down-converter 1346 lowers the carrier frequency while the demodulator 1332 strips away the RF leaving only a digital bit stream. The signal then goes through the equalizer 1328 and is processed by the DSP 1306. A Digital to Analog Converter (DAC) 1318 converts the signal and the resulting output is transmitted to the user through the speaker 1320, all under control of a Main Control Unit (MCU) 1304—which can be implemented as a Central Processing Unit (CPU) (not shown).

The MCU 1304 receives various signals including input signals from the keyboard 1324. The keyboard 1324 and/or the MCU 1304 in combination with other user input components (e.g., the microphone 1312) comprise a user interface circuitry for managing user input. The MCU 1304 runs a user interface software to facilitate user control of at least some functions of the mobile station 1302 for generating the feature data 808A. The MCU 1304 also delivers a display command and a switch command to the display 1308 and to the speech output switch controller, respectively. Further, the MCU 1304 exchanges information with the DSP 1306 and can access an optionally incorporated SIM card 1326 and a memory 1322. In addition, the MCU 1304 executes various control functions required of the station. The DSP 1306 may, depending upon the implementation, perform any of a variety of conventional digital processing functions on the voice signals. Additionally, DSP 1306 determines the background noise level of the local environment from the signals detected by microphone 1312 and sets the gain of microphone 1312 to a level selected to compensate for the natural tendency of the user of the mobile station 1302.

The CODEC 1314 includes the ADC 1316 and DAC 1318. The memory 1322 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1322 may be, but not limited to, a single memory, CD, DVD, ROM, RAM, EEPROM, optical storage, or any other non-volatile or non-transitory storage medium capable of storing digital data.

An optionally incorporated SIM card 1326 carries, for instance, important information, such as the cellular phone number, the carrier supplying service, subscription details, and security information. The SIM card 1326 serves primarily to identify the mobile station 1302 on a radio network. The card 1326 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A system for generating feature data, the system comprising:
at least one processor; and
at least one memory including computer program code for one or more programs,
the at least one memory and the computer program code configured to, with the at least one processor, cause the system to perform at least the following:
determine a set of break points associated with at least one road feature based on mask image data, wherein the mask image data is associated with overhead image data comprising the at least one road feature;
generate a set of cropped feature maps, based on i) processing of a global feature map associated with the overhead image data obtained from a global feature segmentation model, and ii) the set of break points;
generate the feature data associated with the at least one road feature based on i) application of a local feature detection model on the generated set of cropped feature maps and ii) the set of break points; and
store the generated feature data in a geographic database.

2. The system of claim 1, wherein the system is further caused to generate the mask image data based on application of the global feature segmentation model on the overhead image data.

3. The system of claim 1, wherein the overhead image data comprises at least one of: satellite imagery or aerial imagery.

4. The system of claim 1, wherein the system is further caused to:
apply a filter on the mask image data; and
determine the set of break points based on the application of the filter on the mask image data, wherein the set of break points comprises one or more terminal points and one or more junction points.

5. The system of claim 4, wherein the system is further caused to:
identify one or more break points of the set of break points having a relative distance less than or equal to a first threshold distance; and
combine the identified one or more break points of the determined set of break points.

6. The system of claim 1, wherein the processing of the global feature map comprises:
upsampling the global feature map to match a size of the overhead image data in a decoder arm of the global feature segmentation model;
determining a region associated with each of the set of break points in the upsampled global feature map; and
generating the set of cropped feature maps by extracting the corresponding region for each of the set of break points from the upsampled global feature map.

7. The system of claim 1, wherein, to generate the feature data, the system is further caused to determine a plurality of vertices until one or more stop conditions are met, the determination comprises:
selecting a first break point of the set of break points as a current vertex;
applying the local feature detection model on the current vertex and a corresponding cropped feature map of the set of cropped feature maps; and
receiving, as a predicted output of the local feature detection model, a subsequent vertex of the current vertex included in the plurality of vertices and a confidence score associated with the subsequent vertex.

8. The system of claim 7, wherein the system is further caused to:
downsample the set of cropped feature maps; and
apply the local feature detection model on the current vertex and the corresponding cropped feature map of the downsampled set of cropped feature maps.

9. The system of claim 7, wherein, to determine the plurality of vertices, the system is further caused to:
determine that a portion of the at least one road feature in a region included in a cropped feature map of the set of cropped feature maps is associated with a substantially straight geometry, wherein the cropped feature map is associated with a current vertex received as the predicted output from the local feature detection model;
iteratively apply the local feature detection model on a previous vertex received as the predicted output, the current vertex and the corresponding cropped feature map associated with the current vertex, until the one or more stop conditions are met, and
receive, as the predicted output of the local feature detection model, the determined plurality of vertices.

10. The system of claim 7, wherein the system is further caused to:
determine that a portion of the at least one road feature in a region included in a cropped feature map of the set of cropped feature maps is associated with a substantially curved geometry, wherein the cropped feature map is associated with a current vertex received as the predicted output from the local feature detection model;
iteratively apply the local feature detection model on a set of previous vertices received as predicted outputs from the local feature detection model, the current vertex and the corresponding cropped feature map associated with the current vertex, until the one or more stop conditions are met, and
receive, as the predicted output of the local feature detection model, the determined plurality of vertices.

11. The system of claim 7, wherein the one or more stop conditions comprises:
a distance between the subsequent vertex and the current vertex is less than or equal to a second threshold distance; or
a distance between the subsequent vertex and an end point of a cropped feature map that corresponds to a boundary of the overhead image data is less than or equal to a third threshold distance.

12. The system of claim 7, wherein, to generate the feature data, the system is further caused to:
combine the generated mask image data and the determined plurality of vertices;
merge overlapping vertices of the determined plurality of vertices; and
connect vertices of the determined plurality of vertices having a distance less than or equal to a fourth threshold distance.

13. The system of claim 1, wherein the local feature detection model corresponds to a deep learning graph-based model.

14. A method for generating feature data, comprising;
determining a set of break points associated with at least one road feature based on mask image data, wherein the mask image data is associated with overhead image data comprising the at least one road feature;
generating a set of cropped feature maps, based on i) processing of a global feature map associated with the overhead image data obtained from a global feature segmentation model and ii) the set of break points;
generating the feature data associated with the at least one road feature based on i) application of a local feature detection model on the generated set of cropped feature maps and ii) the set of break points; and
storing the generated feature data in a geographic database.

15. The method of claim 14, further comprising generating the mask image data based on application of the global feature segmentation model on the overhead image data.

16. The method of claim 14, further comprising:
applying a filter on the mask image data; and
determining the set of break points based on the application of the filter on the mask image data, wherein the set of break points comprises one or more terminal points and one or more junction points.

17. The method of claim 14, further comprising determining a plurality of vertices until one or more stop conditions are met to generate the feature data, wherein the determining comprises:
selecting a first break point of the set of break points as a current vertex;
applying the local feature detection model on the current vertex and a corresponding cropped feature map of the set of cropped feature maps; and
receiving, as a predicted output of the local feature detection model, a subsequent vertex of the current vertex included in the plurality of vertices and a confidence score associated with the subsequent vertex.

18. The method of claim 14, wherein the processing of the global feature map comprises:
upsampling the global feature map to match a size of the overhead image data in a decoder arm of the global feature segmentation model;
determining a region associated with each of the set of break points in the upsampled global feature map; and
generating the set of cropped feature maps by extracting the corresponding region for each of the set of break points from the upsampled global feature map.

19. A non-transitory computer-readable storage medium carrying one or more sequences of one or more instructions which, when executed by one or more processors, cause an apparatus to perform operations comprising:
determining a set of break points associated with at least one road feature based on mask image data, wherein the mask image data is associated with overhead image data comprising the at least one road feature;
generating a set of cropped feature maps, based on i) processing of a global feature map associated with the overhead image data obtained from a global feature segmentation model and ii) the set of break points;
generating feature data associated with the at least one road feature based on i) application of a local feature detection model on the generated set of cropped feature maps and ii) the set of break points; and
storing the generated feature data in a geographic database.

20. The non-transitory computer-readable storage medium of claim 19, wherein the operations further comprise determining a plurality of vertices until one or more stop conditions are met to generate the feature data, wherein the determining comprises:
selecting a first break point of the set of break points as a current vertex;
applying the local feature detection model on the current vertex and a corresponding cropped feature map of the set of cropped feature maps; and
receiving, as a predicted output of the local feature detection model, a subsequent vertex of the current vertex included in the plurality of vertices and a confidence score associated with the subsequent vertex.
